(19) United States
(12) Patent Application Publication
(10) Pub. No.: US 2015/0073916 A1
(43) Pub. Date: Mar. 12, 2015

(54) CONTENT/ADVERTISING PROFILING

(71) Applicants: Sandilya Bhamidipati, Mountain View, CA (US); Nadia Fawaz, Sunnyvale, CA (US)

(72) Inventors: Sandilya Bhamidipati, Mountain View, CA (US); Nadia Fawaz, Sunnyvale, CA (US)

(73) Assignee: Thomson Licensing, Issy de Moulineaux (FR)

(21) Appl. No.: 14/391,991

(22) PCT Filed: May 24, 2012
(86) PCT No.: PCT/US12/39272

§ 371 Date: Oct. 10, 2014

(51) Int. Cl. G06Q 30/02

(52) U.S. Cl. CPC G06Q 30/0269
USPC 705/14.66

(57) ABSTRACT

A method for providing data indicative of user engagement with content commences by first collecting data measuring user engagement with the content. The data is then aggregated in accordance with user-designated privacy constraints. Thereafter, a content profile is created for the user in accordance with the aggregated user engagement data. The content profile is then either provided to a provider of content, or used to sell services based on that content profile to the content provider

### TECHNICAL FIELD

This invention relates to a technique for profiling content, and particularly, a technique for profiling advertisements, based on user interaction.

### BACKGROUND ART

Content producers typically want to know how viewers perceive content. Given the cost and length of time associated with creating, producing and distributing a full length motion picture or a television series, movie studios carefully consider what scripts to put into production based on based on past successes and failures. In addition, many movie studios typically pre-screen their content with a selected audience in advance of release to the public to gauge potential viewer reaction and to make changes where necessary to improve audience satisfaction.

Producers of advertising also want to know how viewers perceive their content. Today, the cost of producing a short advertisement (e.g., 30 seconds or on minute) has grown dramatically especially for advertisements that include sophisticated special effects. Moreover, the cost of procuring time on radio, television and other media in national markets can prove prohibitive. Thus, before embarking on the production and widespread distribution of one or more advertisements, advertisers often engage in various forms of test marketing to gain user response. In addition, advertisers also survey their target audience on an ongoing basis to determine the continued effectiveness of their advertisements. Advertisements no longer deemed effective are deleted and replaced with others having a higher level of audience satisfaction.

Various companies, such as A.C. Nielsen, New York, N.Y., have developed techniques for querying television viewers for market research purposes. Past efforts to determine television-viewing habits required viewers to fill out paper forms. In an effort to automate the collection of data, such market research companies developed “set meters” and “people meters” connected to viewers' television sets. A set meter captures television channel tuning information, e.g., the channel tuned by a television set at a given time. A people meter gathers both tuning information and viewing information, including who views a particular program and when they do so.

While the use of set meters and people meters automate the collection of viewing data, the use of these devices incurs several disadvantages. First, a physical connection must exist between the device and the television set before data collection can occur. Secondly, these devices collect a limited amount of data. Third, with respect to present day people meters, their use requires viewers identify themselves by pushing their “personal viewing button” on the people meter before watching TV. In addition, present day set meters and people meters only record data for currently broadcast TV programs, and do not provide any information for other video content, such as video-on-demand, or online videos. Further, like the original paper forms for recording viewing information, set meters and people meters do not incorporate any privacy-preserving mechanisms.

Other mechanisms exist for recording viewing information for market research purposes. Hulu, LLC., Los Angeles, Calif., a commercial video streaming company, creates “heat maps” in the form of histograms that capture the popularity of scenes in streamed videos. Such heat maps provide a measure of audience size, but on an expanded basis because such heat maps provide audience information on a per-scene basis. Hulu also asks viewers about the relevance of the advertisements displayed during a streaming video. However, Hulu only generates heat maps for a limited number of streamed videos. Moreover, users can choose not to answer the questions on ad relevance or answer them incorrectly. Lastly, Hulu only provides streaming service in the United States.

Some cable television companies such as Cablevision, Inc., Bethpage, N.Y. capture viewing data and off-line data. Based on such information, the cable company can stream different advertisements to different viewers all tuned to the same channel.

Advertisers who provide on-line advertising (e.g. display advertising, sponsored search advertising) can gain a measure of user engagement by counting the number of users who click on such advertising, often referred to as the “click through rate.” The click through rate provides a useful indication of which advertising slots in a web page gain the most user attention, and thus have greater value. No equivalent system exists for on-line video content beyond the simple heat maps for measuring scene popularity.

Thus, a need exists for measuring user engagement in a systematic way to obtain useful market research information.

### BRIEF SUMMARY OF THE INVENTION

Briefly, in accordance with a preferred embodiment of the present principles, a method for providing data indicative of user interaction with content commences by first collecting data measuring user engagement with the content. The data is then aggregated in accordance with user-designated privacy constraints. Thereafter, a content profile is created for the user in accordance with the aggregated user engagement data. The content profile is then either provided to a provider of content, or used to sell services based on the content profile to the the content provider.

### BRIEF DESCRIPTION OF THE DRAWING

FIG. 1 depicts a block schematic diagram of an exemplary system for practicing the content profiling technique of the present principles.

### DETAILED DESCRIPTION

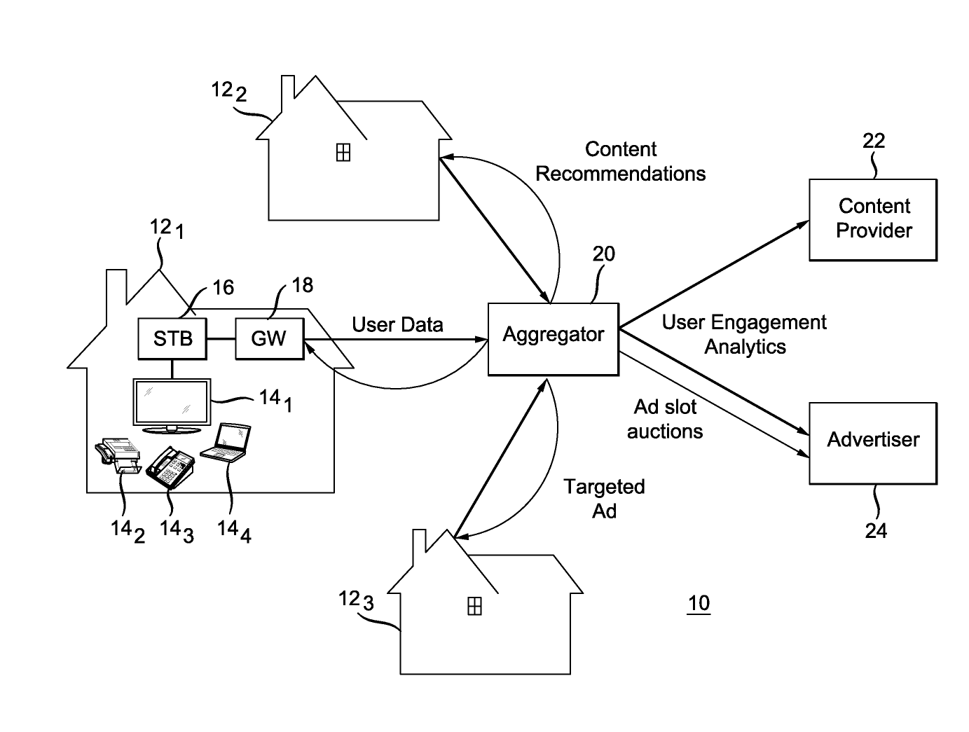

FIG. 1 depicts a block schematic diagram of a system 10 for profiling content in accordance with a preferred embodiment of the present principles. The system 10 accumulates data from users at each of a plurality of premises, illustratively depicted by premises 12₁, 12₂ and 12₃. At each premise, such as premise 12₁, a user (not shown) can make use of one or more devices, exemplified by devices 14₁, 14₂, 14₃, and 14₄, to receive and/or send information. The received information typically takes the form of a feature-length presentation, e.g., a movie or television program (including a program broadcast live or on-demand), together with accompanying advertising. Hereinafter, the term “content” shall refer to either a feature presentation or advertising or the combination of both. The sent information can include user engagement data reflective of the user's engagement with the received content.

By way of example, the device 14₁ can take the form of a television set supplied with content through a set-top box 16 served by a gateway 18. The gateway 18 connects to an aggregator 20, typically in the form of a cable television or network service provider head-end. The aggregator 20 has links to one or more content providers, such as the content provider 22, that provides feature length presentations, for example, movies and television programming, via the aggregator to one or more of the premises 12₁-12₃. In addition to the content provider 22, the aggregator 20 can have links to one or more advertisers, such as advertiser 24 that provide advertising, via the aggregator, to one or more of the premises 12₁-12₃. While the system 10 depicts the content and the advertising as originating separately from the content provider 22 and the advertiser 24, respectively, the content provider could provide both content and advertising.

The device 14₂ can take the form of a remote control for controlling the set-top box 16 to tune to a desired feature length presentation or advertising, if separate from the feature length presentation. The remote control 14₂ also can serve as a mechanism for enabling a user to enter data to the STB 16 for transmission via the gateway 18 to the aggregator 20. In this way, a user can enter data reflective of the user's engagement with the desired feature length presentation or advertising if separate therefrom. Thus, in response to a query displayed on the screen of the television set 14₁ seeking the user's opinion regarding one or more aspects of the displayed feature length presentation or advertising, the user can respond to that query via the remote control 14₂.

In some instances, the set-top box 16 can provide user engagement data even in the absence of user actuation of the remote control 14₂. For example, the set-top box 16 could provide the aggregator 20, via the gateway 18, with information as which channel the user has tuned as well as the duration of that channel tuning In this way, the set-top box 16 can act as a traditional “set-meter” to supply channel information to the aggregator.

The device 14₃ can take the form of a smart phone or a tablet device having a touch-pad display through which the user can watch displayed information as well as enter information in response thereto. In practice, the tablet device 14₃ connects to the gateway 18 over a wireless communications link, such as an IEEE 802.11 wireless link, although other mechanisms readily exist to allow the tablet device to communicate with the gateway. The tablet device 14₃ can serve as a “second screen” to enable a user to watch content different from, but possibly related to the content displayed by the television set 14₁. For example, the tablet device 14₃ can serve to display information about the actors appearing in a movie displayed on the television set 14₁. The user can also use the tablet or his smart phone to browse the web, enter search queries, or purchase items in relationship with the content displayed on the television set 14₁, interact with or inform his social network about the content. In addition to displaying information, the tablet device 14₃ can serve to transmit information from the user to the aggregator 20 via the gateway 18 indicative of the user's engagement with the displayed content.

The device 14₄ can take the form of a computer, such as a lap-top computer that connects to the gateway 18 over a wireless communications link, such as an IEEE 802.11 wireless link. Like the tablet device 14₃, the laptop computer 14₄ can serve as a “second screen” to enable a user to watch content different from, but related to the content displayed by the television set 14₁. Further, like the tablet device 14₃, the laptop computer 14₄ can to transmit information from the user to the aggregator 20 via the gateway 18 indicative of the user's engagement with the content. The laptop, the tablet, and the smart phone can also act as first screens on which the user watch video content that may or may not be available on TV.

The device 14₁-14₄ thus described represent merely examples of the possible devices through which a user can receive content and can send information indicative of the user's engagement with such received content (i.e., “content engagement information”). For example, a user could use a cell phone or so-called “smart phone” to interact with the gateway 18 to receive content and send content engagement information. Other possible devices for sending and receiving information could include a Blu-ray DVD player, having wireless link for connecting to the gateway 18. The devices could receive/send information without necessarily interacting with the gateway. They could do so through a cellular network for example, as long as the information reaches the aggregator.

The content profiling technique of the present principles relies on the content engagement information collected from the different premises 12₁-12₃ through the various devices at each premises, including the devices 14₁-14₄, the set-top box 16 and the gateway 18. As discussed, the content engagement information can include channel tuning Further, such content engagement information can also include data associated with Digital Video Recorder (DVR) operations per scene (play, pause, fast forward, rewind, replay, sequences watched or skipped, as well as advertisements watched or skipped). In addition, the content engagement information can also include content-related to Internet activity, such as online content browsing and/or purchasing by a user). In practice, the user can access the Internet via the gateway 18 through different devices, including, but not limited the tablet device 14₃ or the laptop 14₄, or though a cell phone or smart phone for example. Such one-line activity could also include accessing one or more social networks via which the user will discuss the viewed content, or purchasing online a product advertised in the viewed content.

Although not depicted in FIG. 1, one or more of the premises 12₁-12₃ could include one or more devices for monitoring the user's reaction to the content displayed at that premises. For example, such monitoring devices could include one or more video cameras to monitor the user's facial expressions, such as sadness or laughter during content viewing. Other monitoring devices could include one or more microphones for detecting vocal responses (e.g., laughter) and/or one of more sensors for measuring the user's physiological responses, such as changes in blood pressure, or skin conductivity.

The aggregator 20 receives the content engagement information in various forms from each of the premises 12₁-12₃. The aggregator 20 processes the content information to establish user engagement metrics, taking into account privacy constraints established by the user. The privacy constraint(s) established by each user can take many different forms. For example, in one extreme case, a user could choose “no privacy” which would allow the aggregator 20 to use all of the data from that user for any purpose. On the other hand, in the other extreme case, the use could designate complete privacy in which case the aggregator 20 would not make use of the content engagement information related to that user to compute and release aggregated user engagement analytics.

Various intermediate privacy constraints could exist between the two extremes of no privacy and complete privacy. For example, a user could enter a privacy constraint that would restrict the content engagement information to certain content. For example, the user could permit to aggregator 20 to process all content engagement information related to user interaction with respect to advertisements but not feature presentations or vice versa. The user could also enter a privacy constraint that limited the type of content engagement data available to the aggregator. For example, the user might allow channel-tuning data and data related to DVR operations, but could restrict observational data from cameras present at the premise as well as the user's physiological data. The privacy constraint could also limit data from particular users at a premise. For example, the user-designated privacy constraint could limit the aggregator 20 to processing content engagement information from adults only. The privacy constraints described above illustrate a small number of the wide variety of possible privacy constraints that could exist. The aggregator 20 establishes user content engagement metrics taking into account the user-entered privacy constraints discussed previously. The nature of the user content engagement metric will determine the manner of processing of the incoming content engagement information. For example, an advertiser might want to know how often viewers watch a particular advertisement. A simple approach to establishing that metric would be to monitor how often the user at a given premises tunes to channel(s) at time(s) at which the advertisement appears on such channels. Further, an advertiser might also want to know how much the user enjoyed an advertisement. To establish that metric, the aggregator 20 could process the information received from the camera(s) at a given premise to detect the user's facial expression during playback of the advertisement in question. A more direct approach might be to query the user during or after playback of the advertisement and tally the user-entered response to that query. The aggregator 20 could also establish the user's satisfaction or dissatisfaction to an advertisement by monitoring the user's physiological data, assuming the user-entered privacy constraint permits use of such data. Another indication of the user's satisfaction of a particular piece of content would be whether and how often the user recommended that content to others. An advertiser might also want to know the profile or demographics of users who watch a given advertisement. The techniques described for establishing user engagement metrics for advertising apply equally well to establishing user engagement metrics for feature length presentations.

In addition to establishing user content engagement metrics that indicate the user's satisfaction or dissatisfaction of a particular piece of content, the aggregator 20 can process the content engagement information to build a fine-grained content profile. For example, the aggregator 20 can process the content engagement information to build a content profile that identifies those scenes and/or sequences within a piece of content for which the user indicated his or her enjoyment.

After establishing the user engagement metrics and fine-grained content profiles, the aggregator 20 provides such information to the content provider 22 and advertiser 24, typically in exchange for an agreed-upon compensation. To entice users to provide content engagement information with few or no privacy constraints, the aggregator can share some of the compensation with the user. For example, the aggregator could provide the user with payment in the form of a check or the like. Alternatively, to the extent that the aggregator 20 provides the user with network services, the aggregator could extend a discount to the user for such services depending on the volume of content engagement data provided by the user and the level of privacy constraints placed on such data.

The user content engagement metrics and the fine-grained content profile enables network service operators to increase their revenues by varying the price charged to advertisers, such as advertiser 24 for different advertising time slots. For example, an advertising time slot associated with a high level of user engagement with the content appearing in the time slot will command a higher price than a time slot with a lower level of user engagement. Further, the user engagement metrics and fine grained fine-grained content profile enables a content provider to choose a time slot that maximizes the likelihood that the viewer will watch such content in that time slot. Further, the user engagement metrics and fine-grained -grained content profile enables a content provider, and especially an advertiser, to target feature presentations and advertising to particular users more likely to view such content.

The foregoing describes a technique for profiling content, and especially advertising. The content profiling technique of the present principles has no restrictions on geography or the number of participants and affords ready implementation on a wide scale via a gateway, or other device with Internet access.

1. A method for providing data indicative of user interaction with content, comprising the steps of:
collecting data measuring user engagement with the content;
aggregating the user engagement data in accordance with user-designated privacy constraints; and
creating a content profile in accordance with the aggregated user data for use by a provider of content

2. The method according to claim 2 wherein the user engagement data does not undergo aggregation if the user has designated complete privacy.

3. The method according to claim 1 wherein the step of collecting comprises collecting data indicative of channel tuning by the user.

4. The method according to claim 1 wherein the step of collecting comprises collecting physiological data from the user during content viewing.

5. The method according to claim 1 wherein the step of collecting comprises collecting visual data indicative of user facial expressions during content viewing.

6. The method according to claim 1 wherein the step of collecting comprises collecting audio data indicative of user expressions voiced during content viewing.

7. The method according to claim 1 wherein the step of collecting comprises collecting Digital Video Recorder (DVR) operations per scene.

8. The method according to claim 1 wherein the step of collecting comprises collecting user Internet activity (during content viewing.

9. The method according to claim 1 wherein the content profile indicates how often the user viewed the content.

10. The method according to claim 1 wherein the content profile indicates how much the user enjoyed the content.

11. The method according to claim 9 wherein the content profile indicates how much the user enjoyed individual scenes in the content.

12. The method according to claim 1 further including the steps of providing the content profile to the provider of content in exchange for compensation.
